(19) United States
(12) Patent Application Publication
(10) Pub. No.: US 2023/0017623 A1
(43) Pub. Date: Jan. 19, 2023

(54) Component Arrangement and Method for Producing a Component Arrangement

(71) Applicant: Bayerische Motoren Werke Aktiengesellschaft, Muenchen (DE)

(72) Inventors: Stefan BECK, Kelheim (DE); Philipp ENGELHARDT, Langweid am Lech (DE); Alexander GRIMM, Karlsfeld (DE); Erwin OBERMEIER, Moosburg (DE); Sebastian RACZKOWSKI, Muenchen (DE); Stefan ROHLEDER, Wilnsdorf (DE); Georgij SAFRONOV, Reichertshausen (DE)

(21) Appl. No.: 17/785,568

(22) PCT Filed: Jan. 13, 2021
(86) PCT No.: PCT/EP2021/050506

§ 371 Date: Jun. 15, 2022

(30) Foreign Application Priority Data
Feb. 11, 2020 (DE) 10 2020 103 356.7

(51) Int. Cl. B23K 26/322; B23K 11/11; B23K 26/242

(52) U.S. Cl. CPC B23K 26/322; B23K 11/11; B23K 26/242; B23K 2101/006

(57) ABSTRACT

A component arrangement and a method for producing the component arrangement are provided. The component arrangement includes a first component and a second component, which are arranged in an overlapping arrangement and are connected by a laser fillet weld and at two fixing points arranged laterally offset from the laser fillet weld, one of the components is provided with at least one projection, which projects in the direction of the other component and which is arranged and formed such that, when the components are positioned correctly in relation to one another and are pressed together at the fixing points, a flange portion of the first component, set at an angle in the region of the laser fillet weld to be formed, is pressed onto the second component by way of the component edge. For sealing the component arrangement, the fixing points are arranged set back into the overlapping region with respect to the laser fillet weld, and at least between the fixing points there is formed a continuous bonding region, in which the first and second components are bonded to one another.

### BACKGROUND AND SUMMARY

The invention relates to a component arrangement and to a method for producing a component arrangement.

In laser-beam welding, a focused laser beam with a high power density is directed onto a joint, so that the irradiated material melts. The melt pool is moved by a relative movement between the laser beam and the components to be joined. The cooling melt solidifies and materially connects the components welded to one another. In this case, laser-beam welding is distinguished by a high welding speed and high component flexibility. Furthermore, laser-beam welding requires component accessibility only on one side.

The welding speeds and the flexibility may be increased even further if the laser welding is carried out as remote laser welding. In this case, the laser beam is directed onto and guided over the components by means of a scanner system. The scanner system allows uniaxial or multiaxial deflection of the laser beam. Conventionally, remote laser-beam welding is carried out with a large working distance of, for example, more than 0.4 m from the weld position. Because of the large working distance and the high welding speeds, remote laser-beam welding is carried out without auxiliary material. This results in only a low gap bridging capacity and the need to weld at technical zero clearance. This usually necessitates elaborate clamping systems with which the components are pressed onto one another at the joint.

The components used in vehicle bodywork manufacture furthermore often have an anticorrosion coating, for example a zinc coating. Because of the low boiling temperature of the coating, evaporation of the coating material takes place during the welding. Without sufficient precautions for controlled zinc degassing, this leads to splashes and consequent seam defects, or the need for retreatment, which penalizes laser-beam welding in comparison with, for example, resistance spot welding.

Because of this problem and the high procurement costs of laser welding systems, laser-beam welding has hitherto been used only limitedly in vehicle bodywork manufacture.

The prior German Application 10 2018 128 402.0, not yet published at the priority date of the present application, describes a method in which, by the controlled introduction of design elements into a joining section of a component, by the configuration of the component itself, laser-compliant clamping with a second component is directly possible. The described method straightforwardly allows increased economical use of laser welding methods in order to produce component arrangements. Particularly in the field of vehicle bodywork and the floor assembly, there is a need for such a component arrangement to be sealed at the joint in order to prevent problems of moisture and corrosion.

Against this background, the object of the invention is to provide a way in which an improved component arrangement can be produced with improved sealing by using laser welding processes.

The object is achieved by a component arrangement and method according to the independent claims. Further advantageous configurations may be found from the dependent claims and the following description.

A component arrangement is provided, having a first component and a second component, which are arranged as upper sheet and lower sheet in an overlapping arrangement and are connected by means of a laser fillet weld and at two fixing positions arranged laterally offset with respect to the laser fillet weld, wherein a protrusion is provided on one of the components, which protrudes in the direction of the other component and is arranged and configured in such a way that with accurate positioning of the components with respect to one another and by pressing together at the fixing positions, a flange section of the first component is pressed, while being obliquely set in the region of the laser fillet weld to be formed, with a component edge onto the second component. In this way, at the position where the laser fillet weld is formed, on the one hand a forced zero clearance is produced and furthermore a degassing cavity is provided for the welding process.

In order to ensure improved sealing of the components, the fixing positions are arranged set-back relative to the laser fillet weld in the overlap region, and a continuous adhesive bonding region, in which the first and second components are adhesively bonded to one another, is formed at least between the fixing positions.

A method for producing a component arrangement is furthermore provided, having the steps:

accurate positioning of a first component and a second component in an overlapping arrangement,

pressing together and fixing the two components at least at two fixing positions, wherein an adhesive arranged between the components adhesively bonds the components to one another in a continuous adhesive bonding region extending between the fixing positions, and wherein a protrusion is provided on one of the components, which protrudes in the direction of the other component and is arranged and configured in such a way that by pressing together at the fixing positions, a flange section of the first component is pressed, while being obliquely set, with a component edge onto the second component, and forming a laser fillet weld between the component edge of the first component and the second component.

By the fixing of the components at the fixing positions, a previously introduced adhesive is compressed and forms a continuous adhesive surface, which adhesively bonds the two components tightly to one another in an adhesive bonding region. This adhesive bonding region extends at least between the two fixing positions, although it may also continue laterally and, for example, extend along the entire joining flange. The adhesive bonding region may, for example, extend substantially parallel to the component edge. The adhesive bonding region preferably does not reach as far as the component edge but—like the fixing positions—is offset inward relative to the component edge into the overlap region of the components.

The fixing positions refer to positions at which the components are fixed to one another and are clamped to one another. The fixing of the components may, for example, be carried out by screwing or riveting. Particularly preferably, the two components are connected at the fixing positions by spot welding. The spot welding connection may preferably be configured as a conventional resistance spot welding connection. Resistance spot welding is particularly suitable, because of the mutual force action, in order to compensate for component inaccuracies during the joining and in order to press the components together at the fixing positions. Furthermore a multiplicity of resistance points are conventionally provided particularly on bodywork components. Advantageously, some of these points may be used as fixing positions while further resistance points may be replaced with the laser fillet weld. Resistance spot welding, as an established method in automobile manufacture, may be carried out favorably and reliably in terms of processing.

The joint connections formed at the fixing positions may be designed as pure geopoints, that is to say they may be used for geometrical fixing of the components to one another but may not alone be sufficient to produce a sufficient strength. The laser seam on the spring element section is a welding seam by means of which a sufficiently high strength of the component combination is achieved.

In one configuration of the invention, the protrusion is formed by the flange section i.e. the flange section is set obliquely, so that the component edge of the flange section protrudes in the direction of the second component relative to the adjacent component section. If the components are clamped at the fixing points, the already obliquely set edge section bearing on the second component is clamped more strongly and contact with the component lying underneath is ensured. The flange section may, for example, extend in the form of a ramp in the direction of the second component. Such a flange section may for example be formed by a deep-drawing or stamping process, and may for example already be produced in a shaping step during the production of the first component. Preferably, the flange section configured as a protrusion ends before the adhesive bonding region. The flange section configured as a protrusion may extend into the component interior only a few millimeters, for example less than 10 mm, away from the component edge.

In order to produce a defined zero clearance, it has in this case been found particularly advantageous for the component edge to protrude furthest in a central region of the flange section. The effect of this is that the edge section is initially placed in the central edge region on the second component. During the clamping of the components at the fixing positions, the remaining protruding edge is also pressed onto the component. In this case, particularly uniform bearing may be produced over the entire obliquely set edge.

In a further configuration it is provided that the at least one protrusion is formed in the first component or in the second component and is arranged so that the protrusion in the assembled position of the two components is separated at least with its maximum elevation further than the fixing positions from the component edge to be welded. In other words, the fixing positions are arranged closer than the highest elevation of the protrusion to the component edge. This achieves the effect that, during the pressing of the components together at the fixing positions, the upper sheet or first component is tilted with its component edge onto the lower sheet, or second component, so that the flange section adjacent to the component edge to be welded is in turn arranged at an oblique angle with respect to the second component and the component edge is simultaneously pressed onto the latter with a defined zero clearance.

For particularly reliable production of a technical zero clearance to be produced even over large edge lengths to be welded, it has been found advantageous for the protrusion to have an elongate shape in plan view and for the protrusion to have its maximum elevation in a central region in a longitudinal profile. The longitudinal profile may, for example, be configured in the shape of an arc or in the form of a ramp on both sides. The protrusion is preferably arranged so that its longitudinal extent substantially extends in the longitudinal direction of the component edge. For example, the protrusion may be configured parallel to the component edge to be welded. By the raising of the protrusion in the central region, it is possible to ensure that the component edge to be welded bears over the entire length even in the case of large edge lengths.

The protrusion is preferably formed at the height of the laser welding seam, that is to say laterally offset next to the section of the component edge on which the laser welding seam is or will be formed. When looking from the component edge at the overlap region, the protrusion is preferably arranged behind the welding seam. Viewed from this direction, the fixing positions are likewise arranged behind, but in addition laterally offset with respect to, the laser welding seam, namely offset on the right and left.

In a further configuration, the protrusion has in cross section a ramp-like shape descending toward the component edge. This shape promotes the above-described tilting of the upper component when the components are pressed together at the fixing positions.

For the tilting process, it may also be advantageous for the protrusion to have in plan view a crescent-like shape with ends pointing toward the component edge. This is the case particularly in combination with a centrally raised longitudinal profile of the protrusion.

For the pressing behavior on the component edge, it may furthermore be advantageous for the protrusion to extend over a length which corresponds at least to the length of the laser fillet weld or is longer than the latter.

In order to assist the tilting function of the protrusion described above, in one configuration a further protrusion, which in cross section has a ramp-like shape descending toward the component edge, may respectively be provided next to or at the fixing positions. The further protrusions may, for example, be arranged set-back relative to the component edge behind the fixing positions and offset outward from the fixing positions relative to the laser welding seam to be formed.

The protrusions may be produced in a straightforward manner and without additional outlay directly during the component production, for example in the case of a sheet-metal component by deep drawing or stamping in a pressing installation or during the casting of a cast component. The necessary accuracies for the raising may in this case readily be reproduced.

In addition to the protrusion described above, which causes a tilting movement of the first component, in one configuration an obliquely set flange section may additionally be provided on the first component, as described for the first configuration. This flange section is set obliquely relative to the adjacent first component so that the component edge of the flange section protrudes in the direction of the second component.

In order to improve the degassing during the formation of the laser welding seam, a crescent, which forms a degassing cavity between the components, may in addition respectively be formed in one configuration on the right and left next to the laser welding seam.

Because of the integrated degassing possibilities described above, the component arrangement is suitable in particular for connecting components which are provided with a coating. In one configuration, the first component or the second component or both the first and the second component may therefore be provided with a coating, for example an anticorrosion coating. Both sheet-metal components and cast components may be used as components. The term upper sheet and lower sheet are thus to be interpreted in that they merely refer to the arrangement of the components with respect to one another. An upper sheet in this case denotes the component facing toward the laser beam, and a lower sheet correspondingly denotes the component facing away from the laser beam.

All laser-weldable materials, for example steel materials or aluminum materials, are suitable as materials. The components may, for example, be bodywork components or components fitted on bodywork, for example doors or hatches. It is possible to replace welding points which have hitherto been formed by resistance welding points with remote laser-beam welding seams. The geopoints are now already tacked as resistance points in bodywork manufacture, so that these may be used as fixing points and the method may be integrated into existing method sequences with only minor modifications to the components.

The laser-beam welding is not restricted to a particular method. Remote laser-beam welding is preferably used because of the defined technical zero clearance produced with the method and the possibility of providing defined degassing possibilities.

The solution described above offers the possibility of producing a tight component arrangement, which at the same time has only a small installation space requirement, by using a laser welding method.

Further advantages, features and details of the invention may be found from the following description, in which exemplary embodiments of the invention are described in detail with reference to the drawings. In this case, the features mentioned in the claims and in the description may respectively be essential to the invention on their own or in any combination. Insofar as the term “may” is used in this application, this includes both the technical possibility and the actual technical implementation.

Exemplary embodiments will be explained below with the aid of the appended drawings.

### BRIEF DESCRIPTION OF THE DRAWINGS

FIGS. 1, 1A and 1B are schematic representations of an exemplary component combination in plan, front (before assembly) and side (before assembly) views, respectively.

FIGS. 2, 2A and 2B are schematic representations of an exemplary component combination in plan, front (before assembly) and side (before assembly) views, respectively.

FIGS. 3, 3A and 3B are schematic representations of an exemplary component combination in plan, front (before assembly) and side (before assembly) views, respectively.

FIGS. 4, 4A and 4B are schematic representations of an exemplary component combination in plan, front (before assembly) and side (before assembly) views, respectively.

FIGS. 5, 5A and 5B are schematic representations of an exemplary component combination in plan, front (before assembly) and side (before assembly) views, respectively.

FIGS. 6, 6A and 6B are schematic representations of an exemplary component combination in plan, front (before assembly) and side (before assembly) views, respectively.

### DETAILED DESCRIPTION OF THE DRAWINGS

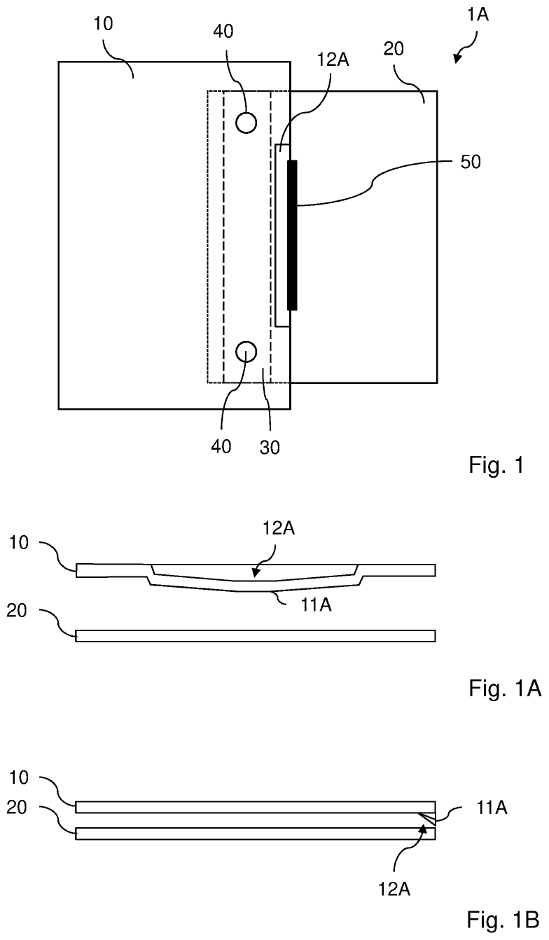

The component combinations 1A to 1F shown in FIGS. 1 to 6 respectively contain a first component or upper sheet 10 and a second component or lower sheet 20, which are arranged in an overlapping arrangement.

In order to produce the component combinations 1A to 1F, the components 10, 12 are positioned accurately with respect to one another, an adhesive being arranged between the components in an adhesive bonding region 30. The components are initially pressed together at the fixing positions 40 with a force-fit and are fixed to one another, preferably by resistance welding points. A laser welding seam 50 is subsequently formed, which extends as a fillet weld along a component edge 11, 11A, 11B of the first component 10 and connects the latter to the second component 20. By the pressing together and fixing, the components are furthermore adhesively bonded to one another in the adhesive bonding region 30. The adhesive bonding region 30 extends at least between the fixing points 40 and preferably over the entire length of the overlap region. The adhesive bonding region 30 extends substantially parallel to the component edge 11, 11A, 11B but—like the fixing points 40—offset inward from the component edge.

In order to produce the laser seam 50, a technical zero clearance is required between the components 10, 20. In order to achieve this without further clamping technology, in the exemplary embodiment of FIG. 1, a flange section 12A adjacent to the component edge 11A is set obliquely in the direction of the lower component 20 and protrudes from the rest of the first component 10. This may be seen in FIGS. 1A and 1B, in which the two components are represented before assembly of the component arrangement. Preferably, the component edge 11A protrudes most in the direction of the second component 20 in a central region and recedes on both sides back in the direction of and to the level of the first component.

If the two components 10, 20 are now brought together in the assembly position, the protruding component edge 11A bears on the second component 20 lying underneath. By pressing together and fixing at the fixing points 40, the pressure is increased further. The increased application pressure in the region of the component edge 11A ensures a technical zero clearance. The component edge 11A may in this case be partially bent back. By the flange section 12A being obliquely set, a degassing cavity is furthermore provided. In this case, even raising in the millimeter range may be sufficient to achieve the desired effect. The obliquely set flange 12A may be made very narrow and protrude only a few millimeters from the component edge 11A into the component interior. The adhesive bonding region 30 is in this configuration arranged behind the flange section 12A as viewed from the component edge 11A. A tight component arrangement, which requires only little installation space, is obtained.

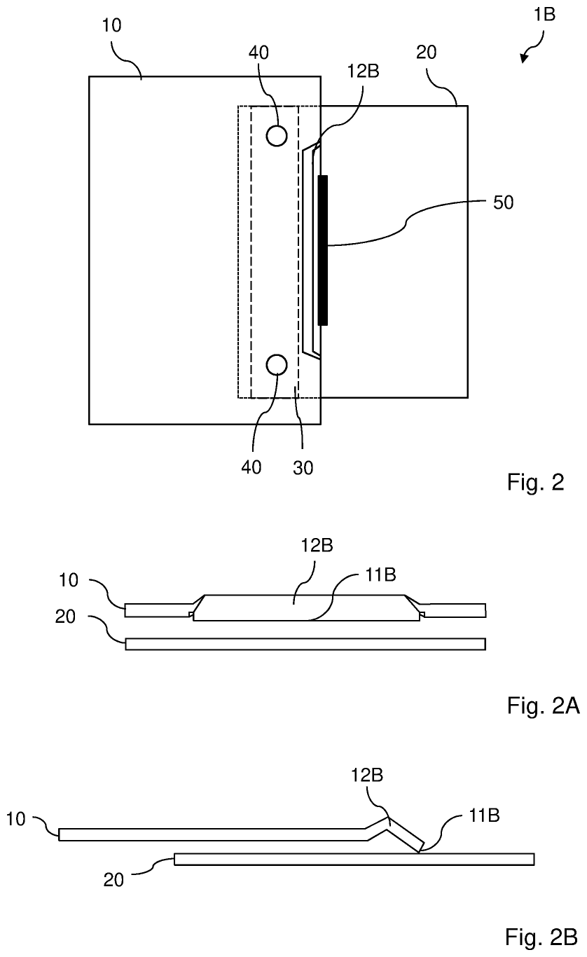

FIG. 2 shows a further exemplary embodiment. This differs from the configuration of FIG. 1 in that the flange section 12B not only is shaped and protrudes with the component edge 11B in the direction of the second component 20, but in that the flange section 12B initially extends upward (away from the second component 20) and only then onto the second component 20 while being obliquely set. This may be seen in FIGS. 2A and 2B. When shaped in this way, the flange section 12B forms a spring element which can yield resiliently when placed onto the second component 20. The component edge 11B to be welded preferably protrudes uniformly relative to the second component 20. The contact between the component edge 11B and the second component 20 is ensured by the spring element. The increased cavity between the components improves degassing during the laser welding process. In addition, two degassing openings 13 laterally adjacent to the component edge to be welded, through which gas can escape in a controlled manner from the cavity between the components, are additionally provided in the first component 10.

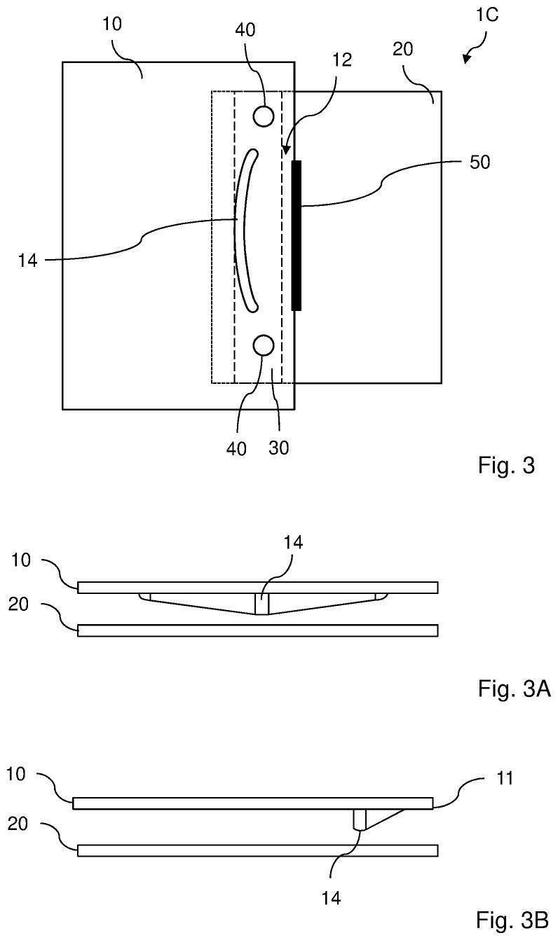

FIGS. 3 to 6 show configurations which select an approach that is different but has an equivalent effect. In this configuration, a protrusion 14, which protrudes in the direction of the second component 20 and is arranged behind the fixing positions 40 with respect to the component edge 11, is formed in the first component 10. If the components 10, 20 are now placed onto one another in the assembly position and pressed against one another at the fixing points 40, the upper sheet 10 tilts with its edge 11 in the direction of the second component 20 and comes to bear with the latter. In this way, the flange section 12 adjacent to the tilted component edge 11 is obliquely set, so that the aforementioned degassing cavity and at the same time a technical zero clearance at the component edge are produced.

FIG. 3 shows an example in which the protrusion 14 has an elongate crescent-like shape in plan view. The ends of the protrusion 14 point toward the component edge, and between the ends the protrusion 14 extends in the shape of a crescent away from the component edge 11 and back toward the latter. As seen in a longitudinal section, the protrusion 14 protrudes most in the central region and descends in the shape of a ramp toward the ends, see FIG. 3A. FIG. 3B shows the cross section of the protrusion 14, which is configured in the shape of a ramp in the direction of the component edge 11 and tails off flatly.

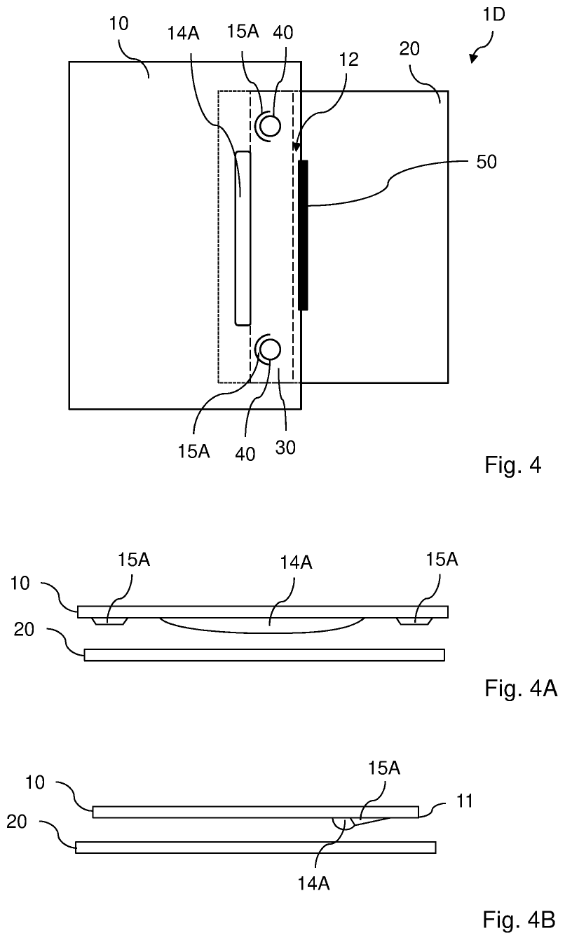

FIG. 4 shows a further exemplary embodiment. The protrusion 14A is again arranged behind the fixing points 40 (as seen from the component edge 11) and has a straight elongate shape in plan view. In longitudinal section, it is configured in the shape of an arc, with the protrusion 14A having the greatest height in the central region. Furthermore, two further protrusions 15A, which protrude in the direction of the second component 20, are provided at the fixing points 40 in the first component. The further protrusions 15A are configured more shallowly in their overall height than the central protrusion 14A. The protrusions 15A are configured in the shape of ramps and each form a ramp descending toward the component edge 11.

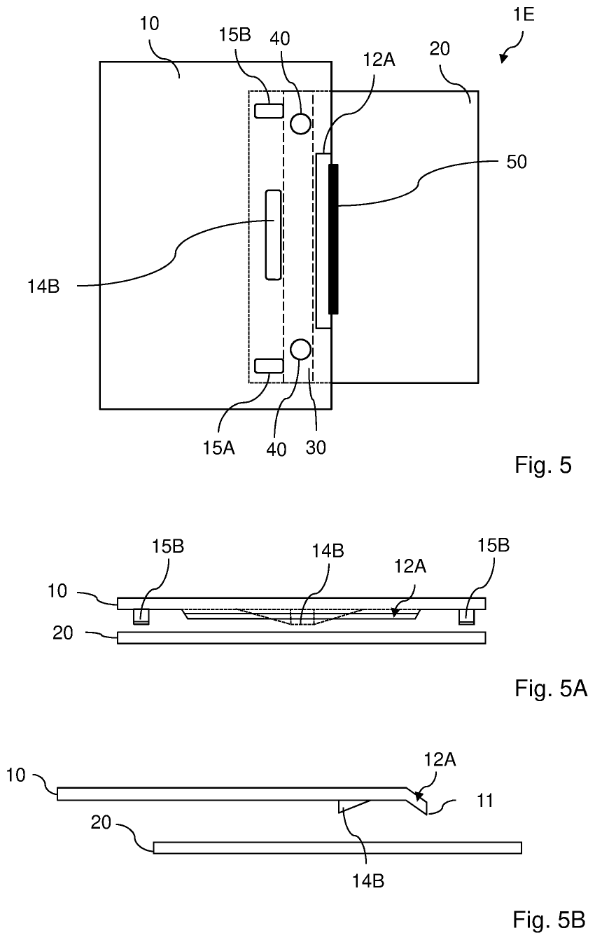

In the configuration according to FIGS. 5, 5A and 5B, the obliquely set flange section 12A of FIG. 1 is combined with three protrusions 14B and 15B arranged behind the fixing positions. The protrusion 14B is configured in plan view as a straight elongate body which is arranged substantially parallel to the component edge 11. As seen in longitudinal section, the protrusion 14B protrudes most relative to the rest of the first component 10 in the central region and its height decreases in the shape of a ramp toward the sides. Arranged next to the fixing positions 40, there are two further protrusions 15B, which are respectively configured as ramps descending toward the component edge. The protrusions 15B are set back in relation to the welding seam 50, or component edge 11, behind the fixing positions 40.

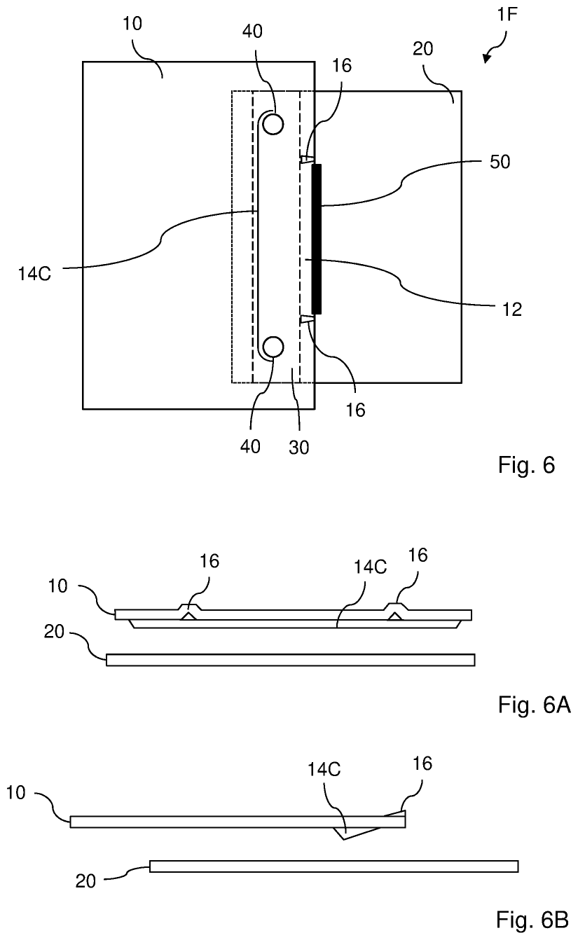

FIG. 6 shows a configuration in which a protrusion 14C is provided, the latter extending as a straight body in plan view between the fixing positions 40 and continuing beyond the latter. The protrusion 14C is configured in the shape of a ramp as seen in cross section, its greatest height in relation to the component edge 11 being formed behind the fixing positions 40. In this exemplary embodiment, the protrusion is also arranged in the adhesive bonding region 30. In order to improve the degassing, a crescent 16, by which a possibility of degassing transversely with respect to the component edge is provided, is respectively arranged on the component edge 11 on the right and left laterally next to the laser seam 50.

The protrusions 14, 14A, 14B, 14C, 15A and 15B shown in FIGS. 3 to 6 may also be formed in the second component 20 instead of in the first component 10.

### LIST OF REFERENCES

1A-1F component combination
10 component
11, 11A, 11B component edge
12, 12A, 12B flange section
13 degassing opening
14, 14A, 14B, 14C protrusion
15A, 15B protrusion
16 crescent
20 component
30 adhesive bonding region
40 fixing positions
50 laser welding seam

1.-13. (canceled)

14. A component arrangement, comprising:
a first component and a second component, which are arranged in an overlapping arrangement and are connected via a laser fillet weld, and are connected at two fixing positions arranged laterally offset with respect to the laser fillet weld, wherein
at least one protrusion is provided on one of the components, which protrudes in a direction of the other component and is arranged and configured such that with accurate positioning of the first and second components with respect to one another and by pressing together at the two fixing positions, a flange section of the first component is pressed, while being obliquely set in the region of the laser fillet weld to be formed, with the component edge onto the second component,
the two fixing positions are arranged set back relative to the laser fillet weld in the overlap region, and
a continuous adhesive bonding region, in which the first and second components are adhesively bonded to one another, is formed at least between the two fixing positions.

15. The component arrangement according to claim 14, wherein
the first and the second component are respectively connected to one another by a resistance spot weld at the two fixing positions.

16. The component arrangement according to claim 14, wherein
the at least one protrusion is formed by the flange section and the flange section is set obliquely relative to the surrounding first component, so that the component edge of the flange section protrudes in the direction of the second component.

17. The component arrangement according to claim 16, wherein
the component edge protrudes furthest in a central region of the flange section.

18. The component arrangement according to claim 14, wherein
the at least one protrusion is formed in the first component or in the second component and is arranged so that the protrusion in an assembled position of the first and second components is separated at least with a maximum elevation further than the two fixing positions from the component edge to be welded.

19. The component arrangement according to claim 18, wherein
the protrusion has in plan view an elongate shape and the protrusion has a maximum elevation in a central region in a longitudinal profile.

20. The component arrangement according to claim 18, wherein
the protrusion has in cross section a ramp shape descending toward the component edge.

21. The component arrangement according to claim 18, wherein
the protrusion has in plan view a crescent shape with ends pointing toward the component edge.

22. The component arrangement according to claim 18, wherein
the protrusion extends over a length which corresponds at least to a length of the laser fillet weld.

23. The component arrangement according to claim 18, wherein
a further protrusion, which in cross section has a ramp shape descending toward the component edge, is respectively provided next to or at the two fixing positions.

24. The component arrangement according to claim 18, wherein
a flange section is additionally set obliquely relative to the adjacent first component so that the component edge of the flange section protrudes in the direction of the second component.

25. The component arrangement according to claim 14, wherein
a crescent, which forms a degassing cavity between the first and second components, is respectively formed on the right and left next to the laser fillet welding seam on the component edge.

26. A method for producing a component arrangement, comprising:
accurately positioning a first component and a second component in an overlapping arrangement;
pressing together and fixing the first and second components at least at two fixing positions, wherein an adhesive arranged between the two components adhesively bonds the two components to one another in a continuous adhesive bonding region extending between the two fixing positions, and wherein a protrusion is provided on one of the components, which protrudes in a direction of the other component and is arranged and configured such that by pressing together at the two fixing positions, a flange section of the first component is pressed, while being obliquely set, with a component edge onto the second component; and
forming a laser fillet weld between the component edge of the first component and the second component.
